(19) United States
(12) Patent Application Publication
(10) Pub. No.: US 2012/0272494 A1
(43) Pub. Date: Nov. 1, 2012

(54) METHOD FOR CORRECTING A SOFT FOOT IN A LARGE GENERATOR

(76) Inventor: Daniel Markeson, Poulsbo, WA (US)

(21) Appl. No.: 13/095,062

(22) Filed: Apr. 27, 2011

(51) Int. Cl. B23P 6/00

(52) U.S. Cl. 29/402.01

(57) ABSTRACT

A method of correcting a soft foot on a large machine such as a generator including the steps of detecting the soft foot, elevating the end of the machine having the soft foot while keeping the opposing feet level, measuring the distance to the supporting surface, placing the appropriate Skim to assure identical weight bearing on opposing feet and relocating the machine for operation.

### TECHNICAL FIELD

This invention relates to the proper maintenance and operation of large machinery, such as generators and electric motors, wherein the improper installation of the machinery leads to a soft foot, which could lead to excessive vibration and destruction of the machine.

### BACKGROUND OF THE INVENTION

Large machines, such as electric generators and electric motors, are intended to be permanently mounted and aligned with complementary devices for rotation therewith. As will be obvious, the proper alignment of the mechanisms results in lower maintenance and longer life. The proper alignment of these machines relies upon the fact that the machines are securely mounted to the supporting surface and that they are evenly supported to maintain the alignment.

Prior art known to the inventor dealing with the alignment and/or leveling of heavy machinery includes:

U.S. Pat. No. 3,250,503 granted to Karstens on May 10, 1966, which teaches the utilization of a plurality of jacks to ensure the levelness of heavy machines such as electric motors and generators, wherein the top and bottom of the jack are not necessarily parallel, thus ensuring an even support across the surface of the supporting jack.

U.S. Pat. No. 4,157,066 granted to Pretty on Jun. 5, 1979, teaches a hydraulic mechanism controlling the approach and separation of relatively movable platens of a press.

U.S. Pat. No. 4,828,474 granted to Ballantyne on May 9, 1989, teaches a hydraulic cylinder device for control and platen spacing indication for a press.

U.S. Pat. No. 4,784,058 granted to Nakagawa et al on Nov. 15, 1988, teaches a device for control and maintenance of level position and uniform pressure on a workpiece.

U.S. Pat. No. 5,156,782 granted to Ballantyne on Oct. 20, 1992, teaches a hydraulic means for maintaining press platens in a parallel relationship.

U.S. Pat. No. 6,171,092 granted to Galt et al on Jan. 9, 2001, teaches a platen sensing and alignment apparatus.

Chinese Publication No. CN201205568(Y) published on Mar. 11, 2009, teaches the utilization of a double gantry movable structure to level a cabinet.

### SUMMARY OF THE INVENTION

With the above-noted prior art in mind, as well as inherent problems known to the inventor, it is the goal of the present invention to provide a method of detecting a soft foot in a heavy machine, such as a generator or electric motor, and correcting the soft foot. This may be done as a separate exercise, or alternatively may be done as a part of an alignment process.

The inventive process involves the steps of detecting the soft foot on the generator or electric motor, lifting one end of the generator or electric motor while keeping the supporting feet level, measuring the distance from each foot to the supporting surface, and placing the appropriate shim under the foot to ensure that the level will be retained, and then replacing the electric motor or generator to the operating position.

### BRIEF DESCRIPTION OF THE DRAWINGS

FIG. 1 is a flow diagram illustrating the steps required to remove the soft foot in heavy machinery.

FIG. 2 is a schematic illustrating one method of lifting the end of heavy machinery.

### BEST MODE FOR CARRYING OUT THE INVENTION

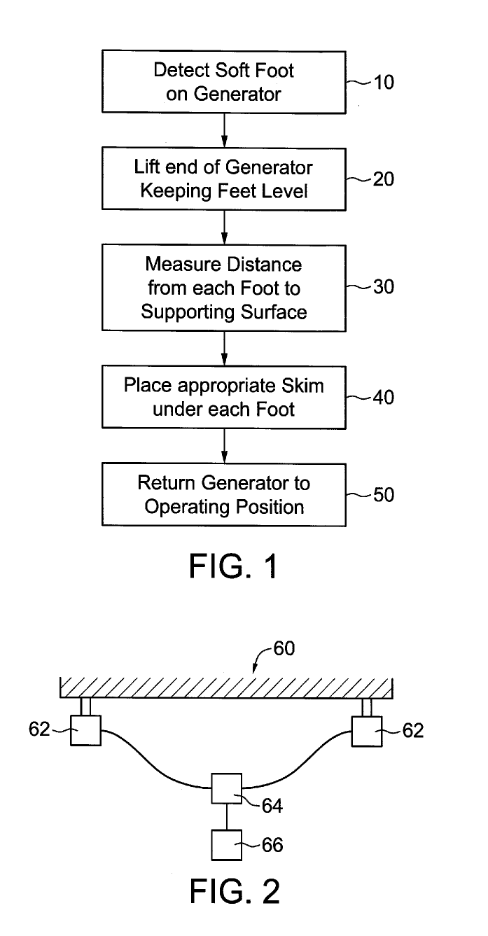

As seen in FIG. 1, the first step 20 in correcting the support and/or alignment of large electric generators and/or motors involves the detection of the soft foot, which can be accomplished in any one of several ways, including the detection of excessive vibration in the suspected foot or the opposite foot, lifting the machine along a center line such that the feet at one end of the machine would naturally be level, or using hydraulic jacks at one end of the machine wherein the jacks are identical in size and are powered by a common pump such that they are assured of an identical pressure, thus elevating the machine while keeping the feet level.

Once the machine has been lifted and the feet at one end are level, then the distance is measured from the bottom of the foot to the supporting surface as at 30, and a determination if made as to the correct amount of shim to be placed under each foot 40, and then the generator is returned at secured in its operating position 50.

Since the size of the machinery severely limits the ability to make a single lift at the center line, the machine 60 is lifted by a pair of identical cylinders 62, wherein the fluid for the hydraulic cylinder is provided by a single pump through an manifold 64, thus ensuring that the fluid pressure to each one of the lifting cylinders 62 is identical.

Although a preferred embodiment has been disclosed for purposes of illustration, it should be understood that various changes and modifications and substitutions could be made in the preferred embodiment without departing from the spirit of the invention as defined by the claims which follow:

What is claimed is:

1. A method of correcting a soft foot in a large machine such as a generator, comprising:
a) detecting the soft foot;
b) elevating one end of the machine, keeping both feet level;
c) measuring the distance from each foot to the supporting surface;
d) placing the appropriate shim beneath each foot to assure the machine is level when returning the machine to its operating position; and
e) returning the machine to its operating position.

2. A method as in claim 1, wherein the elevation is done hydraulically.

3. A method as in claim 2, wherein the elevation is done using a cylinder under each foot.

4. A method as in claim 3, wherein each cylinder is driven by the same pump.

5. A method as in claim 3, wherein the cylinders are the same size.
